(19) United States
(12) Patent Application Publication
(10) Pub. No.: US 2025/0187022 A1
(43) Pub. Date: Jun. 12, 2025

(54) PROCESS FOR SEPARATING IRON-BEARING IMPURITIES FROM A HOST MATRIX

(71) Applicant: BHMPC INVESTMENTS PTY LTD, Highgate (AU)

(72) Inventors: Steven John HOBAN, Highgate (AU); Robert KOCHMANSKI, Highgate (AU)

(21) Appl. No.: 18/702,774

(22) PCT Filed: Oct. 26, 2022
(86) PCT No.: PCT/AU2022/051288

§ 371 Date: Apr. 18, 2024

(30) Foreign Application Priority Data
Nov. 2, 2021 (AU) 2021903501

(51) Int. Cl. B03D 1/016; C01B 33/18

(52) U.S. Cl. CPC B03D 1/016; C01B 33/18; B03D 2201/007; B03D 2201/02; B03D 2203/04; C01P 2006/80

(57) ABSTRACT

A process for separating iron-bearing impurities from silica sand is described. The process comprises the steps of subjecting a silica sand slurry to froth flotation in the presence of a collector, frother and depressant selected to concentrate the iron-bearing impurities of the silica sand in a flotation froth, thereby producing a silica sand depleted in iron-bearing impurities in a tail product. The collector comprises ≥60 to ≤70 w/w % tall oil acids, ≥10 to ≤30 w/w % poly-α-hydroxyl alkyl ethers and up to 3 w/w % tall oil rosin. The frother comprises a non-ionic surfactant, in particular one or more alkyl polypropoxy CₙPₘ and/or polyethoxy CₙEₘ frothers, wherein n=0-6 and m=1-3. The depressant comprises sodium silicate.

### TECHNICAL FIELD

The disclosure relates to a process for separating iron-bearing impurities from a host matrix, in particular to a froth flotation process for separating iron-bearing impurities from silica sands.

### BACKGROUND

The discussion of the background to the disclosure is intended to facilitate an understanding of the disclosure. However, it should be appreciated that the discussion is not an acknowledgement or admission that any of the material referred to was published, known or part of the common general knowledge as at the priority date of the application.

Silica sand is a primary feedstock for glass manufacturing and is subject to increased demand from the construction market, rising automotive production and sales, abrasives, and hydraulic fracturing. There is also growing global demand for specialty glass for photovoltaic cells and mobile phones as well as lithium-ion batteries, resulting in a demand for high-purity silica sand with minimal contamination by aluminium-, iron-, titanium-, calcium-, magnesium- and potassium-bearing impurities.

Iron-bearing impurities may be generally present in any one of three types, including:
a) liberated and free iron mineralogy contained in fines (−106 μm);
b) silica particle surface coatings that can be mechanically removed; and
c) coarse particle, discreet heavy minerals such as haematite, magnetite or ilmenite.

The first type of iron-bearing impurity may be managed and removed via simple screening and cycloning techniques, the second type may be addressed via particle attritioning and the third may be removed by spiral gravity techniques.

However, some silica sand deposits comprise much less discreet and more variable iron speciation. In particular, potassium aluminium silicates such as feldspar and muscovite may contain significant iron alteration within the mineral matrix. For example, low feldspar (LF) may contain up to 3000 ppm Fe₂O₃, moderate feldspar (MF) may contain from 3000-5000 ppm Fe₂O₃ and high iron low feldspar (HILF) may contain >5000 ppm Fe₂O₃. Although conventional separation processes as discussed above may reduce the iron grade to about 700 ppm Fe₂O₃, they fail to produce a final product with an iron grade below 500 ppm Fe₂O₃ to meet high purity silica specifications.

The process described herein seeks to provide an alternative process for separation of iron-bearing impurities from silica sands, in particular to reduce the iron-bearing impurities content to <500 ppm Fe₂O₃.

### SUMMARY

The disclosure provides a process for separating iron-bearing impurities from a host matrix, such as silica sands.

One aspect of the disclosure provides a process for separating iron-bearing impurities from silica sand, the process comprising:
subjecting a silica sand slurry to froth flotation in the presence of a collector, frother and depressant selected to concentrate the iron-bearing impurities of the silica sand in a flotation froth, thereby producing a silica sand depleted in iron-bearing impurities in a tail product, wherein the collector comprises ≥60 to ≤70 w/w % tall oil acids, ≥10 to ≤30 w/w % poly-α-hydroxyl alkyl ethers and up to 3 w/w % tall oil rosin.

In one embodiment, the collector may be present in an amount of 200-800 g/t.

In one embodiment the depressant comprises sodium silicate. The depressant may be present in an amount of 25-250 g/t.

In another embodiment, the frother comprises a non-ionic surfactant, in particular one or more alkyl polypropoxy CₙPₘ and/or polyethoxy CₙEₘ frothers, wherein n=0-6 and m=1-3. The frother may be present in an amount of 5-100 g/t.

In one embodiment, the silica sand slurry has a solids content of from 25-45 wt % solids, in particular 28-40 wt % solids.

In one embodiment, the froth flotation is performed in a neutral pH range, in particular from about pH 7.2 to about pH 7.5. In some embodiments, a buffering agent may be added to maintain the pH in the neutral pH range. Suitable buffering agents include sodium carbonate. The buffering agent may be present in an amount of 10-150 g/t.

In one embodiment, prior to subjecting the silica sand slurry to froth flotation, the silica sand may undergo particle size reduction and classification to provide a top size in a range of 250-1200 μm. The particle size reduction step may be performed with high pressure grinding rolls (HPGR) exerting from 20-40 bar compressive force and having a roll speed of 10-20 rpm. The operational parameters of the HPGR may be conveniently selected to provide a desired top size product to meet specification requirements.

Advantageously, the froth flotation process may be used to separate iron-bearing impurities from coarse silica sand comprising silica sand particles >425 μm or fine silica sand comprising silica sand particles <425 μm.

It will be appreciated that coarse particles are more likely to settle and bog the flotation cells, detracting from their performance and the separation and removal of iron-impurities from the silica sand. Accordingly, although the froth flotation process as described herein may be performed in conventional tanks or Denver flotation cells when the particle size of the flotation feed material is <425 μm, the inventors recommend using a HydroFloat cell when 20% or more of the flotation feed material is >425 μm.

A further aspect of the disclosure provides silica sand having less than 500 ppm Fe₂O₃, wherein said silica sand is produced according to the froth flotation process defined above.

### BRIEF DESCRIPTION OF DRAWINGS

Notwithstanding any other forms which may fall within the scope of the process as set forth in the Summary, specific embodiments will now be described with reference to the accompanying FIGURES below:

FIG. 1 is a flow sheet in accordance with one embodiment of the process for separating iron-bearing impurities from silica sands.

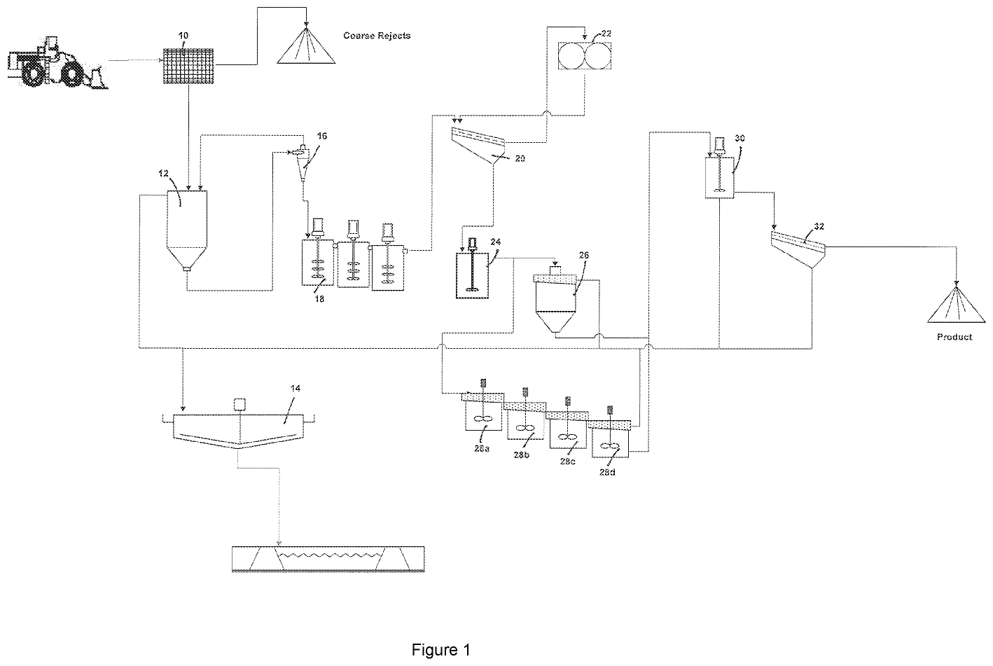

### DESCRIPTION OF EMBODIMENTS

The disclosure relates to a process for separating iron-bearing impurities from silica sands.

### General Terms

Throughout this specification, unless specifically stated otherwise or the context requires otherwise, reference to a single step, composition of matter, group of steps or group of compositions of matter shall be taken to encompass one and a plurality (i.e. one or more) of those steps, compositions of matter, groups of steps or groups of compositions of matter. Thus, as used herein, the singular forms “a”, “an” and “the” include plural aspects unless the context clearly dictates otherwise. For example, reference to “a” includes a single as well as two or more; reference to “an” includes a single as well as two or more; reference to “the” includes a single as well as two or more and so forth.

Each example of the present disclosure described herein is to be applied mutatis mutandis to each and every other example unless specifically stated otherwise. The present disclosure is not to be limited in scope by the specific examples described herein, which are intended for the purpose of exemplification only. Functionally-equivalent products, compositions and methods are clearly within the scope of the disclosure as described herein.

The term “and/or”, e.g., “X and/or Y” shall be understood to mean either “X and Y” or “X or Y” and shall be taken to provide explicit support for both meanings or for either meaning.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the present specification, including definitions, will control. In addition, the materials, methods, and examples are illustrative only and not intended to be limiting.

The term “about” as used herein means within 5%, and more preferably within 1%, of a given value or range. For example, “about 3.7%” means from 3.5 to 3.9%, preferably from 3.66 to 3.74%. When the term “about” is associated with a range of values, e.g., “about X % to Y %”, the term “about” is intended to modify both the lower (X) and upper (Y) values of the recited range. For example, “about 20% to 40%” is equivalent to “about 20% to about 40%”.

### Specific Terms

The term ‘froth flotation’ as used herein refers to a hydrometallurgical process for selectively separating solid particles of hydrophobic minerals from non-hydrophobic minerals in a slurry mixture. It is particularly useful in separating fine solids from other solids in a liquid mixture by the selective attachment of hydrophobic solid particles to gas bubbles contained in the liquid mixture. Gas, typically air, is passed through the liquid mixture at a rate to provide a sustained “froth” or accumulation of bubbles at the liquid-surface interface. The density difference between the gas bubbles and liquid provides the attached hydrophobic solid particles with buoyancy, lifting these particles to the surface and leaving the hydrophilic solid particles behind in the slurry. The hydrophobic solid particles concentrated at the surface may then be separated from the slurry by draining the slurry or by mechanically skimming the surface.

The term ‘frother’ as used herein refers to a chemical substance or a chemical composition (i.e. mixture of chemical substances) used in froth flotation to stabilise the gas bubbles carrying the hydrophobic solid particles to the surface. The frother may include polar (i.e. hydrophilic) and non-polar (i.e. hydrophobic) chemical moieties whereby, in use, the frother increases the surface tension at the liquid-air interface, thereby stabilising the gas bubbles in the froth.

The term ‘collector’ as used herein refers to a chemical substance or a chemical composition (i.e. mixture of chemical substances) used in froth flotation that is capable of physically or chemically adsorbing onto a surface of a particle to increase the particle's wetting ability and thereby enhance attachment to air bubbles and concentration of the particle in the froth.

The term ‘depressant’ as used herein refers to a chemical substance or a chemical composition (i.e. mixture of chemical substances) used in froth flotation that is capable of selectively inhibiting the interaction of a mineral particle with air bubbles so that the mineral particle remains in the slurry rather than concentrating in the froth.

A surfactant is an amphiphilic organic compound containing a hydrophobic (i.e. water-insoluble) moiety and a hydrophilic (i.e. water-soluble) moiety, thereby making it capable of lowering the interfacial tension between two fluids, such as a gas and a liquid. The hydrophobic moiety extends out of the bulk water phase into the gas while the hydrophilic moiety remains in the aqueous phase. The term ‘non-ionic surfactant’ as used herein refers to a surfactant having a hydrophilic moiety that is uncharged. Typically, the hydrophilic moiety will contain oxygen groups that engage in hydrogen bonding in the aqueous phase. Examples of non-ionic surfactants include, but are not limited to, fatty alcohol ethyoxylates, alkylphenol ethoxylates, fatty acid ethyoxylates, ethoxylated amines and/or fatty acid amides, fatty acid esters of polyhydroxy compounds, fatty acid esters of glycerol, fatty acid esters of sorbitol, fatty acid esters of sucrose and alkyl polyglucosides.

The term ‘alkyl’ as used herein refers to substituted or unsubstituted saturated hydrocarbon groups, including straight-chain alkyl and branched-chain alkyl groups that contain from 1 to up to 22 carbons in the chain.

The term ‘alkoxy’ refers to an alkyl group having an oxygen attached thereto. Representative alkoxy groups include methoxy, ethoxy, propoxy, n-butoxy, i-butoxy, tert-butoxy and the like.

The term ‘alkyl ether’ refers to two hydrocarbon groups linked by an oxygen. The term ‘alpha hydroxy ether’ refers to an alkyl ether wherein the hydrocarbon group is substituted with a hydroxyl group on the adjacent carbon to the oxygen ether linkage.

The term ‘tall oil acids’ as used herein refers to a mixture of oleic, linoleic and rosin acids derived from the hydrolysis of tall oil, a byproduct of wood pulp. The term ‘tall oil rosin’ as used herein refers to a distillation product of crude tall oil. It is a mixture of resin acids including but not limited to abietic, ihydroabietic, palustric, neoabietic, isopimaric and may contain up to 6% unsaponifiable matter.

Process to Separate Iron-Bearing Impurities from Host Matrix

Embodiments described herein generally relate to a process to separate iron-bearing impurities from a host matrix, in particular silica sand or quartz.

The iron-bearing impurity separated by the process as described herein may comprise free iron, iron oxides such as magnetite, haematite, ilmenite and limonite; iron sulphides such as pyrite, marcasite and pyrrhotite; iron silicates such as chamosite, silomelane, greenalite, minnesotaite, grunerite; and, in particular, iron-stained feldspars and muscovites.

Referring to the FIGURE, there is shown a process flowsheet for producing silica sand having less than 500 ppm Fe₂O₃ from an as-mined silica sand feed containing iron-bearing impurities.

Said as-mined silica sand is passed through a scrubber 10 to wash clay contamination, gangue mineralisation and organic matter therefrom. Coarse particles of +1 mm may also be rejected. The scrubber 10 may be any suitable conventional scrubber such as a trommel scrubber, drum washing scrubber or rotary scrubber.

The washed and screened silica sand may then be optionally passed to a constant density tank 12. The overflow (fine material) separated from the constant density tank 12 is then pumped at constant density and feed rate to a thickener tank 14. The underflow (or coarser material) is fed to a hydrocyclone 16 where an overflow (fine material) is fed back to the constant density tank 12 and underflow is passed to one or more attritioners 18 arranged in series.

The one or more attritioner(s) 18 clean the particle surface of the silica sands, thereby increasing removal of iron-bearing impurities. Generally, the silica sands may be attritioned for about 20 minutes. The attritioner(s) 18 may be arranged with one or more up-current classifiers to reject fines. Generally, fines have a particle size <100 μm but it will be appreciated by those skilled in the art that the particle size definition of fines may vary according to the desired sales product specification. It will be readily apparent to those skilled in the art to select an appropriate sized up-current classifier to reject fines according to the desired sales product specification.

The attritioned silica sand is then passed to a particle sizing screen 20. Coarse oversize is passed to high pressure grinding rolls (HPGR) 22 where the silica sand undergoes particle size reduction and classification to provide a top size in a range of 250-1200 μm. The HPGR may be operated to exert from 20-40 bar compressive force and a roll speed of 10-20 rpm. The operational parameters of the HPGR may be conveniently selected to provide a desired top size product to meet specification requirements.

Top size product from the HPGR 22 is subsequently passed via the particle sizing screen 20 to a mixing tank 24 where it is mixed with water to produce a silica sand slurry having a solids content of about 25-45 wt % solids, in particular about 28-40 wt % solids. The mixing tank 24 may conveniently operate as a conditioning tank where one or more of a collector, frother, depressant and buffering agent may be added to the slurry. Alternatively, one or more of the collector, frother, depressant and buffering agent may be added to the slurry in a conditioning vessel 26. The slurry may remain in the conditioning tank 26 for a suitable residence time of from about 30 seconds to 120 seconds.

The conditioned slurry may then be passed to a flotation cell 28, in particular a plurality of flotation cells 28a, 28b, 28c, 28d arranged in series. The flotation cells 28a, 28b, 28c, 28d may be conventional flotation tanks or Denver flotation cells, in particular when the particle size of the flotation feed material is <425 μm. Coarse particles are more likely to settle and bog the flotation cells, detracting from their performance and the separation and removal of iron-impurities from the silica sand. Accordingly, when 20% of more of the flotation feed material is >425 μm, the inventors recommend using a flotation cell 28 comprising a HydroFloat cell.

It will be appreciated that the frother may be added to either the conditioning vessel 26 prior to flotation or to the first flotation cell 28a directly, depending on the period of time and agitation required to disperse it within the slurry.

The frother acts to facilitate the generation of a stabilized froth to aid in the recovery of fine particles. The iron-bearing particles are concentrated through attachment of these particles to stable air bubbles which rise to the top of the flotation cell. Other reagents can assist with selective collection of the desired iron-bearing particles and depression of the silica sand.

The frother may be selected from a group of alkyl polypropoxy CₙPₘ and/or alkyl polyethoxy CₙEₘ frothers comprising C₄H₉O(C₂H₄O)₁H, C₄H₉O(C₂H₄O)₃H, C₁H₃O(C₃H₆O)₂H, C₄H₉O(C₂H₄O)₂H, C₆H₁₃O(C₂H₄O)₂H, (C₃H₆O)₃H, C₃H₇O(C₃H₆O)₃H, C₄H₉O(C₃H₆O)₃H. In particular the frother comprises a propoxylated butanol, such as Polyfroth® H27.

The frother may be present in the slurry in an amount of 5-100 g/t. In embodiments wherein the flotation cell comprises a HydroFloat cell, the frother may be present in the slurry in an amount of 50-100 g/t. In alternative embodiments, wherein the flotation cell comprises a conventional flotation tank or a Denver flotation cell, the frother may be present in the slurry in an amount of 5 to 30 g/t.

The depressant maximises silica recovery by keeping the bulk mass of silica sand from floating with the target particles. One suitable example of the depressant includes sodium silicate. Sodium silicate performs well as a depressant at neutral pH. Other depressants, such as sodium and calcium lignosulphonates may also behave as silica depressants at neutral pH but those depressants having a tendency to contribute to over-frothing behaviour are less desirable.

The amount of depressant present in the slurry is primarily dependent on the particle size distribution whereby a finer flotation feed particle size distribution requires elevated depressant dosages. The depressant may be present in an amount of 25 to 250 g/t.

The collector adheres to and activates the surfaces of the iron-bearing impurities, in particular iron-stained feldspar species, by surface activation of highly cationic species. The silica sand (predominantly quartz) remains somewhat inert and unaffected by the collector, thereby enhancing separation of the target iron-bearing impurity particles into the froth and retention of the silica sand particles in the slurry.

The collector may comprise ≥60 to ≤70 w/w % tall oil acids, ≥10 to ≤30 w/w % poly-α-hydroxyl alkyl ethers and up to 3 w/w % tall oil rosin. The collector may be present in an amount of 200-800 g/t.

The collector may have additional depressant and frothing properties. Accordingly, it will be appreciated that the concentration of depressant and frother may be decreased when the collector is present at higher dosages of >600 g/t.

The froth flotation is performed in a neutral pH range, in particular from about pH 7.2 to about pH 7.5. The inventors have noted that the process is sensitive to pH as it drifts away from neutrality. In particular, the effectiveness of the collector performance deteriorates in acidic conditions. Accordingly, a buffering agent may be added to maintain the pH in the neutral pH range. Suitable buffering agents include, but are not limited to, sodium carbonate.

Advantageously, performing the froth flotation in a neutral pH range alleviates environmental concerns frequently associated with obtaining approval for processes operating at high or low pH. Accordingly, the froth flotation process as described herein is much more environmentally benign than prior art processes used to separate iron impurities from silica sands,

The collector generates acid as it dissolves in water, so the amount of buffering agent will be related to the amount of collector present in the slurry. The buffering agent may be present in an amount of 10-150 g/t.

The froth concentrate enriched with iron-bearing particles is then collected from the top of the flotation cell(s) either passively by over spilling into collection launders or by mechanical skimming. The underflow of slurry containing silica sand depleted in iron-bearing impurities is then directed to a surge tank 30 and undergoes classification in a product screen 32 according to desired customer specification.

The following table describes the resulting products produced from the process by subjecting various feeds to a froth flotation process as described herein.

| | Head Grade | | | Product Grade | | | | |
|---|---|---|---|---|---|---|---|---|
| | SiO₂ | Fe₂O₃ | Al₂O₃ | Mass | SiO₂ | Al₂O₃ | Fe₂O₃ | TiO₂ |
| Sample | % | ppm | ppm | % | % | ppm | ppm | ppm |
| LF | 98.279 | 2830 | 7690 | 82.4% | 99.462 | 2,050 | 370 | 350 |
| MF | 97.478 | 4150 | 11320 | 78.6% | 99.337 | 2,590 | 420 | 360 |
| HIHF | 94.62 | 8620 | 26240 | 75.2% | 99.238 | 3,860 | 470 | 330 |

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

In the claims which follow and in the preceding description except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A process for separating iron-bearing impurities from silica sand, the process comprising:
subjecting a silica sand slurry to froth flotation in the presence of a collector, frother and depressant selected to concentrate the iron-bearing impurities of the silica sand in a flotation froth, thereby producing a silica sand depleted in iron-bearing impurities in a tail product, wherein the collector comprises ≥60 to ≤70 w/w % tall oil acids, ≥10 to ≤30 w/w % poly-α-hydroxyl alkyl ethers and up to 3 w/w % tall oil rosin.

2. The process according to claim 1, wherein the frother comprises a non-ionic surfactant, in particular one or more alkyl polypropoxy CₙPₘ and/or polyethoxy CₙEₘ frothers, wherein n=0-6 and m=1-3.

3. The process according to claim 1, wherein the depressant comprises sodium silicate.

4. The process according to claim 1, wherein the collector is present in an amount of 200-800 g/t.

5. The process according to claim 1, wherein the depressant is present in an amount of 25-250 g/t.

6. The process according to claim 1, wherein the frother is present in an amount of 5-100 g/t.

7. The process according to claim 1, wherein the silica sand slurry has a solids content of from 25-45 wt % solids.

8. The process according to claim 1, wherein the froth flotation is performed in a neutral pH range of from about pH 7.2 to about pH 7.5.

9. The process according to claim 8, wherein a buffering agent is added to maintain the pH in said neutral pH range.

10. The process according to claim 9, wherein the buffering agent is present in an amount of 10-150 g/t.

11. The process according to claim 1, wherein the iron-bearing impurities are reduced to <500 ppm Fe₂O₃ in the separated silica sand product.

12. The process according to claim 1, wherein prior to subjecting the silica sand slurry to froth flotation, the silica sand undergoes particle size reduction and classification to provide a top size in a range of 250-1200 μm.

13. The process according to claim 12, wherein the particle size reduction step is performed with high pressure grinding rolls (HPGR) exerting from 20-40 bar compressive force and having a roll speed of 10-20 rpm.

14. Silica sand having less than 500 ppm Fe₂O₃, wherein said silica sand is produced in a froth flotation process according to claim 1.
